(19) United States
(12) Patent Application Publication
(10) Pub. No.: US 2026/0007094 A1
(43) Pub. Date: Jan. 8, 2026

(54) MODULAR AGRICULTURAL HEADER

(71) Applicant: Deere & Company, Moline, IL (US)

(72) Inventors: SCOTT N. CLARK, BETTENDORF, IA (US); JOHN P. ANDRUCH, III, LE CLAIRE, IA (US); FEDERICO PARDINA-MALBRAN, FORT COLLINS, CO (US); AARON S. RITTER, MILAN, IL (US); CHELSEA L. KRIST, LIVONIA, MI (US); ANURAAG PUJARI, MOLINE, IL (US)

(21) Appl. No.: 18/761,551

(22) Filed: Jul. 2, 2024

(51) Int. Cl. A01D 34/01; A01D 45/02; A01D 101/00

(52) U.S. Cl. CPC A01D 34/015; A01D 45/021; A01D 2101/00

(57) ABSTRACT

A modular agricultural header may include a first portion including a mount configured to selectively couple to an agricultural harvester; a second portion defining a first lateral end of the agricultural header; a third portion defining a second lateral end of the agricultural header, opposite the first lateral end; and a first modular row unit disposed between one of the first portion and the second portion or the first portion and the third portion. A separation distance between one of the first portion and the second portion or the first portion and the third portion may be altered in response to coupling or decoupling of the modular row unit therebetween.

### FIELD OF THE DISCLOSURE

The present disclosure relates generally to agricultural headers and, particularly, to modular agricultural headers.

### BACKGROUND OF THE DISCLOSURE

Agricultural harvesters, such as combine harvesters, forage harvesters, and windrowers, utilize agricultural implements, such as an agricultural header. In some instances, headers attach to a feederhouse of the agricultural harvester. Some headers, such as a draper header, includes a base assembly that supports a cutter bar, a reel, and draper belts. As the combine harvester travels, the header engages and severs crop and transfers the severed crop into the combine harvester for further processing. The reel rotates to guide the incoming crop into engagement with the cutter bar to sever the incoming crop and to bias the severed crop onto the draper belts that move the severed crop towards the feederhouse for ingestion into the harvester. Corn headers include a plurality of harvesting units that operate to cut corn stalks, strip corn ears from the corn stalks, and transport the ears to the feederhouse.

### SUMMARY OF THE DISCLOSURE

A first aspect of the present disclosure is directed to a modular agricultural header that may include a first portion including a mount configured to selectively couple to an agricultural harvester; a second portion defining a first lateral end of the agricultural header; and a first modular row unit removably disposed between the first portion and the second portion or the first portion and the third portion. A separation distance between the first portion and the second portion may be altered in response to coupling or decoupling of the first modular row unit therebetween.

Another aspect of the present disclosure is directed to an agricultural header that may include an engagement portion configured to connect to an agricultural harvester; a first end portion disposed at a first lateral end of the agricultural header; a second end portion disposed at a second lateral end of the agricultural header; a plurality of modular row units; and a width. A first portion of the plurality of modular row units may be removable disposed and interconnected between the engagement portion and the first end portion, and a second portion of the plurality of modular row units may be disposed and interconnected between the engagement portion and the second end portion. Each of the modular row units may occupy a position between the engagement portion and the respective one of the first end portion or the second end portion. Each of the plurality of modular row units may be selectively removable from associated position. The width may be altered in response to addition or removal of one or more of the plurality of modular row units from the associated space thereof.

Another aspect of the present disclosure is directed to method for converting, for transportation, a modular agricultural header. The method may include one of selectively adding one or more of the modular row units to the first portion of modular row units or the second portion of the modular row units or removing one or more of the modular row units from the first portion of modular row units or the second portion of the modular row units and altering a lateral width of the agricultural header in response to the one of selectively adding one or more of the modular row units to the first portion of modular row units or the second portion of the modular row units or removing one or more of the modular row units from the first portion of modular row units or the second portion of the modular row units.

Another aspect of the present disclosure is directed to a method that may include disconnecting a first modular row unit of the first portion of the plurality of modular row units from one of an adjacent modular row unit of the first portion of the plurality of modular row units or the engagement portion to form a first transport portion; locating the first transport portion to an aft end of the agricultural harvester; and connecting the first transport portion to the aft end of the agricultural harvester.

The various aspects may include one or more of the following features. A third portion may define a second lateral end of the agricultural header, opposite the first lateral end. A second modular row unit may be removably disposed between the first portion and the third portion. A coupler may be disposed between the first modular row unit and the first portion, between the first modular row unit and the second portion, or between the first modular row unit and a second modular row unit. The coupler may include a connection for at least one of the group consisting of a hydraulic connection, an electrical connection, a structural connection, a drive connection, and combinations thereof. The coupler may be formed on the first modular row unit. The first modular row unit may include an engagement site to which a portion of the coupler removably attaches. The coupler may include a first coupler. The first coupler may be formed on a first side of the first modular row unit, and the first modular unit may include an engagement site configured to engage with a second coupler. The first modular row unit may include a first ground engaging component proximate a leading end of the first modular row unit and a second ground engaging component proximate to a trailing end of the first modular row unit. The second ground engaging component may include a track assembly or a wheel. The second ground engaging component may be powered and configured to propel the first modular row unit along a surface. The first ground engaging component may be steerable.

The various aspects may include one or more of the following features. A coupling may be disposed between and connecting adjacent modular row units. Each of the modular row units may include a first lateral side and a second lateral side, and the first lateral side may include a coupler. The coupler may be configured to connect to an adjacent modular row unit, and the second lateral side may include an engagement site configured to engage with a coupler of an adjacent modular row unit to form a connection therebetween.

The various aspects may include one or more of the following features. Altering a lateral width of the agricultural header in response to selectively adding one or more of the modular row units to the first portion of modular row units or the second portion of the modular row units may include disconnecting a first modular row unit of the plurality of modular row units from one of an adjacent modular row unit of the plurality of modular row units, the first lateral end portion, the second lateral end portion, or the engagement portion; increasing a separation distance between the first lateral end portion and the second lateral end portion to form a gap; inserting second row unit in the gap between the first lateral end portion and the second lateral end portion; coupling a first lateral side of the second modular row unit to the first modular row of the plurality of modular row units; and coupling a second lateral side of the second modular row unit to one of the adjacent modular row unit, the first lateral end portion, the second lateral end portion, or the engagement portion. Altering a lateral width of the agricultural header in response to selectively removing one or more of the modular row units from the first portion of modular row units or the second portion of the modular row units may include disconnecting a first modular row unit of the plurality of modular row units from one of an adjacent modular row unit of the plurality of modular row units, the first lateral end portion, the second lateral end portion, or the engagement portion; removing the first modular row unit to form a gap between the first lateral end portion and the second lateral end portion; decreasing a separation distance between the first lateral end portion and the second lateral end portion to eliminate the gap; and coupling the adjacent modular row unit to one of a second modular row of the plurality of modular row units, the first lateral end portion, the second lateral end portion, or the engagement portion.

The various aspects may include one or more of the following features. The first transport portion may be oriented in a longitudinal arrangement. A first modular row unit of the second portion of the plurality of modular row units may be disconnected from one of an adjacent modular row unit of the second portion of the plurality of modular row units or the engagement portion to form a second transport portion, and the first transport portion may be connected to the second transport portion to form a consolidated transport portion. connecting the first transport portion to the aft end of the agricultural harvester may include connecting the consolidated transport portion to the aft end of the agricultural harvester. Orienting the first transport portion in the longitudinal arrangement may include orienting the consolidated transport portion in the longitudinal arrangement.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is a plan view of an example agricultural harvester with a modular agricultural header attached to a feederhouse of the agricultural harvester.

FIG. 2 is a diagrammatic view top view of an example modular agricultural header.

FIG. 3 is a diagrammatic view top view of the example modular agricultural header of FIG. 2 with a modular row unit decoupled and displaced.

FIG. 4 is a diagrammatic view top view of the example modular agricultural header of FIG. 2 with a lateral end portion coupled with another modular row units of the modular agricultural header, resulting in the modular agricultural header having a reduced width.

FIG. 5 is a diagrammatic to view of an example agricultural harvester having a feederhouse connected with a modular agricultural header.

FIG. 6 is a diagrammatic to view of an example agricultural harvester of FIG. 5 with portions of the modular agricultural header relocated aft of and connected to the agricultural harvester for transport.

FIGS. 7 and 8 are diagrammatic top and side views of an example modular row unit for a modular draper header.

FIGS. 9 and 10 are diagrammatic top and side views of another example modular row unit for a modular corn header.

FIG. 11 is a diagrammatic side view of an example lateral end portion of an example modular agricultural header.

FIG. 12 is a flowchart of an example flowchart for altering a configuration of a modular agricultural header.

FIG. 13 is a flowchart of an example method for converting a modular agricultural header for transport.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

Words of orientation, such as “up,” “down,” “top,” “bottom,” “above,” “below,” “leading,” “trailing,” “front,” “back,” “forward,” and “rearward,” used in the context of the provided examples, would be understood by one skilled in the art and are not intended to be limiting to the disclosure. For example, for a particular type of vehicle in a conventional configuration and orientation and being operated in a conventional manner, one skilled in the art would understand these terms in the context in which they are used and as those terms apply to a particular vehicle. For example, one skilled in the art would appreciate what the forward direction is in the context of a direction that an agricultural harvester normally moves when actively harvesting crop during a crop harvesting operation. Further, one skilled in the art would appreciate what the reverse direction would be for the agricultural harvester during normal operation of the agricultural harvester.

Additionally, the term “forward” (and the like) corresponds to a forward direction of travel of a work machine (e.g., header or combine harvester), such as during a harvesting operation. Likewise, the term “rearward” or “reverse” (and the like) corresponds to a direction opposite the forward direction of travel. In this regard, for example, a “forward facing” feature on a header may generally face in the direction that the head travels during normal operation, while a “rearward facing” feature may generally face opposite that direction.

Also as used herein, with respect to a work machine, unless otherwise defined or limited, the term “leading” (and the like) indicates a direction of travel of the work machine during normal operation (e.g., the forward direction of travel of a harvester vehicle carrying a header) or indicates a position on a work machine of a portion of the work machine that is ahead of another component in the context of a direction of movement of the work machine. Similarly, the term “trailing” (and the like) indicates a direction that is opposite the leading direction or indicates a position on a work machine of a portion of the work machine that trails or is behind of another component in the context of a direction of movement of the work machine. In this regard, for example, a “leading” edge of a header may be generally disposed at the front of the header, with respect to the direction travel of the header during normal operation (e.g., as carried by a combine harvester). Likewise, a “trailing” edge of a header may be generally disposed at the back of the header opposite the leading edge, with respect to the direction of travel of the header during normal operation.

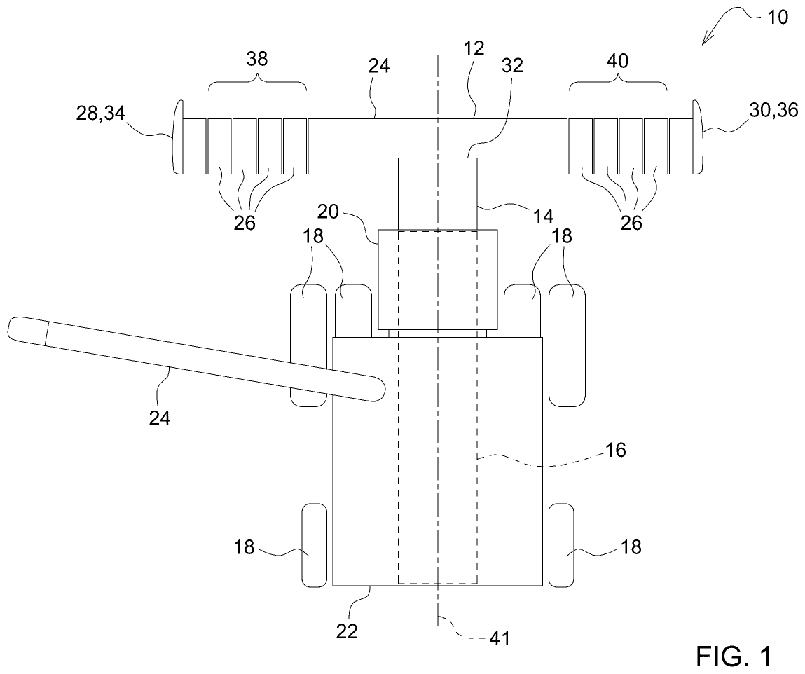

FIG. 1 is a plan view of an example agricultural harvester 10 with a modular agricultural header 12 attached to a feederhouse 14 of the agricultural harvester 10. In this example, the agricultural harvester 10 is a combine harvester. However, the scope of the present disclosure encompasses other types of agricultural harvesters, such as forage harvesters.

The agricultural harvester 10 includes a frame 16, ground engaging components 18 rotatably coupled to the frame 16, a cab 20 mounted to the frame 16, and a body 22 mounted to the frame 16. In some implementations, such as in the example of a combine harvester, crop processing systems are provided in the body 22, such as to thresh and separate grain from the harvested crop. An unloader 24 is connected to the body 22 and operates to unload clean grain from the agricultural harvester 10, such as to a grain cart or other container. Example ground engaging components 18 include wheels, tires, track assemblies, and combinations thereof. Further, the ground engaging components 18 may include other devices operable to transport the agricultural harvester 10 over a surface. In some implementations, one or more of the ground engaging components 18 is powered. In some implementations, one or more of the ground engaging components 18 is steerable to alter a direction of travel of the agricultural harvester 10.

The modular agricultural header 12 includes an engagement portion 24, plurality of modular row units 26, a first lateral end portion 28, and a second lateral end portion 30. The engagement portion 24 is configured to connect or otherwise engage with the feederhouse 14 of the agricultural harvester 10. For example, in some instances, the engagement portion 24 includes a frame 32 configured to engage with the feederhouse 14 to securely connect the engagement portion 24 with the feederhouse 14. In other implementations, the engagement portion 25 and the feederhouse 14 include complementary features that interconnect to secure the engagement portion 24 to the feederhouse 14. When connected, the engagement portion 24, and, by extension, the entire modular agricultural header 12, moves with the feederhouse 14 and, more generally, with the combine harvester 10. The first and second lateral end portions 28 and 30 define opposing lateral ends 34 and 36, respectively, of the modular agricultural header 12.

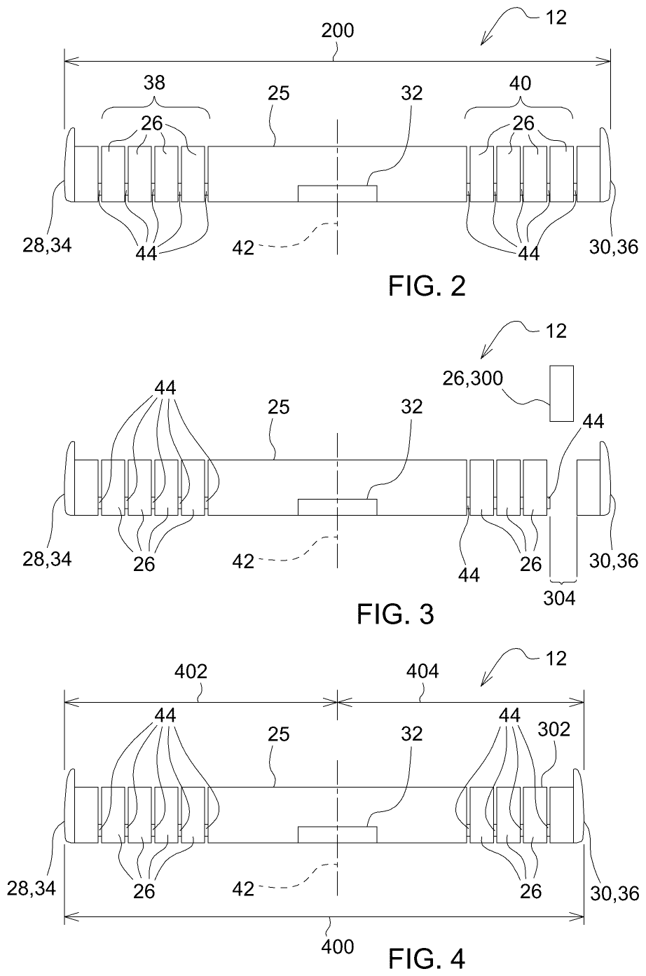

The plurality of modular row units 26 are divided into a first portion 38 of modular row units 26 and a second portion 40 of modular row units 26. With reference to and in the context of FIG. 1, the first portion 38 of modular row units 26 is disposed on the left-hand side of a longitudinal centerline 41 of the agricultural harvester 10, and the second portion 40 of modular row units 26 are disposed on a right-hand side of the centerline 41. Each of the modular row units 26 can be selectively added to or removed from the modular agricultural header 12. For example, FIGS. 2, 3, and 4 illustrate an alteration of a size, e.g., a width 200, of the example modular agricultural header 12 associated with the removal of one of the modular row units 26.

FIG. 2 is a diagrammatic top view of the modular agricultural header 12. In this example, the modular agricultural header 12 includes eight total modular row units 26, with four modular row units 26 in the first portion 38 of modular row units 26 and four row modular row units 26 in the second portion 40 of modular row units 26. In other implementations, the first portion 38, the second portion 40, or both may include additional or few modular row units 26.

In FIG. 3, one of the modular row units 26 of the second portion 40 of the modular row units 26 is disconnected (identified for clarity with reference number 300) from the adjacent modular row unit 26 (identified for clarity with reference number 302). In FIG. 3, the disconnected modular row unit 300 is shown displaced from alignment with the other modular row units 26. As a result, the absence of the disconnected row unit 300 creates a gap 304 between the adjacent modular row unit 302 and the second lateral end portion 30. Although the disconnected modular row unit 300 is one that was directly adjacent to the second lateral end portion 30, in other implementations, any of the modular row units 26 could be disconnected. Further, although one modular row unit 26 is shown removed in the example of FIG. 2, in other instances, more than one modular row unit 26 could be removed. With the disconnected modular row unit 300 removed from the modular agricultural header 12, the modular agricultural header 12 is reconstituted by joining the adjacent modular row unit 302 to the second lateral end portion 30, as shown in FIG. 4. As a result, the reconstituted agricultural header 12 in the present example includes four modular row units 26 in the first portion 38 of modular row units 26 and three modular row units 26 in the second portion 40 of the modular row units 26. Further, a width 400 of the modified modular agricultural header 12 is less than the width 200 as a result of the omitted modular row unit 300. Thus, with addition or removal of one or more modular row units 26, the width of the modular agricultural header 12 can change.

Further, in some instances, such as where more modular row units 26 is removed from one of the first portion 38 or second portion 40 compared to the other of the first portion 38 or second portion 40 or where more modular row units 26 is added to one of the first portion 38 or second portion 40, one of the first lateral end 34 or second lateral end 36 will extend a greater distance from a longitudinal centerline 42 of the modular agricultural header 12. For example, referring again to FIG. 4, a distance 402 that extends from the centerline 42 to the first lateral end 34 is greater than a distance 404 that extends from the centerline 42 to the second lateral end 36.

A benefit provided by modular agricultural headers as described herein is the ability to remove one or more modular row units that may be malfunctioning or damaged, reassemble the modular agricultural header without the malfunctioning or damaged modular row units and continue a harvesting operation with the modified modular agricultural header. In this way, a modular agricultural header that experiences a problem, such as a malfunctioning or damaged modular row unit, can continue to be used to effectively harvest crop once the one or more damaged or malfunctioning modular row units is removed.

Still further, a malfunction or damage to a modular row unit is not required. That is, one more modular row units can be added to or omitted from the modular agricultural header for any desired reason. For example, a width of the modular agricultural header, e.g., width 200 or 400, may be modified, e.g., reduced, to facilitate a breakthrough pass when opening a field or transport of an agricultural header along a road. For example, during a breakthrough pass of a field, it may be desirable to have one of the lateral ends of the agricultural header to extend farther from the header centerline, e.g., centerline 42, than the other lateral end. Consequently, the addition to or removal of one or more modular row units from a first portion of the modular row units, e.g., first portion 38, or a second portion of the modular row units, e.g., second portion 40, compared to the other of the first portion or second portion causes the modular agricultural header to become laterally asymmetrical, as shown, for example in FIG. 4. Thus, in some instances, a laterally asymmetric agricultural header may be desirable and is made possible by the present disclosure by the addition or removal of one or more modular row units. In some instances, it may be desirable to increase a width of the modular agricultural header. In such instances, one or more modular row units may be added to one or both lateral sides of the modular agricultural header. In some instances, increasing a size of a header in a field having a reduced overall yield would improve utilization of resources, such as by reducing an amount of fuel consumed during harvest and an amount of time to harvester, thereby reducing labor costs.

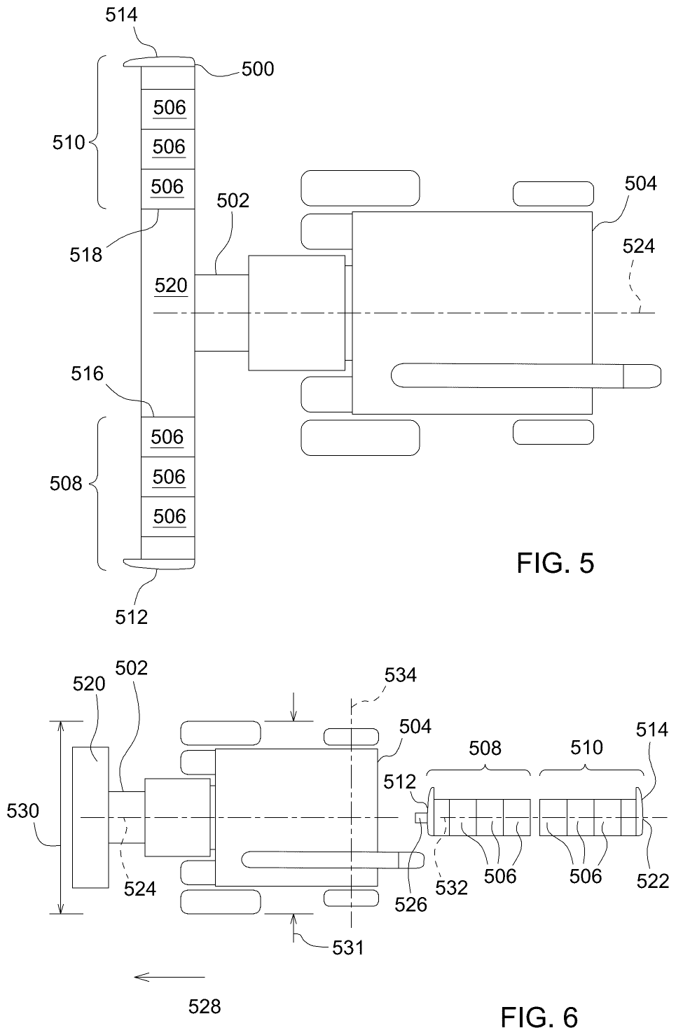

Another instance where one or more modular row units, e.g., modular row units 26, may be desirable to remove apart from any malfunction or damage is in the context of transport. Transporting a harvester, such as a combine harvester, along a roadway with the agricultural header attached can be problematic. Lateral clearance required in such a configuration is made difficult, for example, due to the obstacles along the sides of the roadway (e.g., utility poles, fences, mailboxes, trees, etc.), other vehicles (e.g., vehicle passing in an opposite direction), or other items that would interfere with the agricultural header. To avoid these issues, as shown in FIGS. 5 and 6, modular agricultural header 500 (which may be similar to modular agricultural header 12) is rearrangeable as described to facilitate transportation of the modular agricultural header 500 from one location to another, such as from one field to another.

The modular agricultural header 500 is connected to a feederhouse 502 of combine harvester 504, which may be similar to agricultural harvester 10. In this example, the modular agricultural header 500 includes three modular row units 506 on a first side portion 508 of the modular agricultural header 500 and three modular row units 506 on a second side portion 510 of the modular agricultural header 500. Although three modular row units 506 are illustrated on each side portion 508, 510, in other implementations, a different number of modular row units 506 may be used. Further, in some implementations, a different number of modular row units 506 may be used on the different side portions 508, 510.

The first side portion 508 includes the three modular row units 506 as well as a first lateral end portion 512, and the second side portion 510 includes the three row units 506 as well as a second lateral end portion 514. The first and second side portions 508 and 510 are connected to lateral sides 516, 518 of an engagement portion 520. The engagement portion 520 is connected to the feederhouse 502.

To facilitate transportation of the modular agricultural header 500 to another location, the first and second side portions 508 and 510 are disconnected from the engagement portion 520 and connected together to form a transport assembly 522. In some implementations, the transport assembly 522 is aligned longitudinally, as shown in FIG. 6. In some implementations, the transport assembly 522 may align with or be parallel with a longitudinal axis 524 of the agricultural harvester 504. In some implementations, the side portions 508 and 510 may be laterally oriented, such that an axis 532 of the side portions 508 and 510 are parallel with a lateral axis 534, and longitudinally arranged behind the agricultural harvester 504 for transport by the agricultural harvester 504. In some implementations, the lateral axis 534 is perpendicular to longitudinal axis 524. The transport assembly 522 is coupled to the agricultural harvester 504 with a connector 526, which may include, for example, a bar, rod, beam, assembly, or other structure. The connector 26 is operable to connect the transport 522 to the agricultural harvester 504 for transportation of the transport assembly 522 in response to movement of the agricultural harvester 504, e.g., movement in a direction indicated by arrow 528. In some implementations, the first side portion 508 and the second side portion 510, whether or not combined to form the transport assembly 522, can be loaded onto a trailer that can be connected to and moved by the agricultural harvester 504.

The example modular agricultural header 500 shown in FIGS. 5 and 6 is shown having all of the modular row units 506 of both side portions 508 and 510 disconnected from the engagement portion for transportation purposes. However, in other implementations, fewer than all of the modular row units 506 may be disconnected. For example, in some implementations, one or more modular row units 506 may remain connected to the engagement portion 520 when transporting the modular agricultural header 500 from one location to another. Further, in some implementations, a different number of modular row units 506 may remain connected to one of the lateral sides 516 and 518 of the engagement portion 520 than on the other of the lateral sides 516 and 518. In some instances, the number of modular row units 506 removed from the agricultural harvester 504 or, viewed alternatively, the number of modular row units 506 that are remain connected from the engagement portion 520 when transporting the modular agricultural header 500 is selected based on a desired resulting lateral width 530. The lateral width 530 may be selected to conform to a width of a roadway or otherwise a width that would avoid causing a collision between an object (e.g., fences, utility poles, trees, other vehicles) as the agricultural harvester 504 moves from one location to another. In some instances, the selected lateral width 530 may be a width that is less than or equal to a lateral width 531 of the agricultural harvester 504.

In some implementations, modular row units include ground engagement components, discussed in more detail below, for example, to facilitate transportation of the modular row units from one locations. For example, in a context similar to that shown in FIGS. 5 and 6, these ground engaging components facilitate movement of the modular row units 506 to a location behind the agricultural harvester 504 as well as, in some instances, movement in response to being pulled by the agricultural harvester 504.

In some implementations, modular row units are connected with a coupler. Further, in some implementations, couplers are used to connect a modular row unit, e.g., modular row unit 26 or modular row unit 506, to a lateral end portion, e.g., a lateral end portions 28, 30, 512, and 514, of a modular agricultural header, e.g., modular agricultural headers 12 and 500. Also, a coupler can be used to connect a modular row unit to an engagement portion of the modular agricultural header. In some instances, couplers are interchangeable from one location on a modular agricultural header to another. In still other instances, a coupler is used to connect a lateral end portion to an engagement portion of a modular agricultural header. FIGS. 2, 3, and 4 show the modular agricultural header 12 including couplers 44 that interconnect the modular row units 26, the lateral end portions 28, 30, and the engagement portion 24 within the modular agricultural header 12. Although not illustrated, the modular agricultural header 500 discussed earlier also includes couplers to interconnect the modular row units 506, the lateral end portions 512, 514, and the engagement portion 520.

An example coupler, such as coupler 44, includes, for example, a structural aspect that operates to physically connect adjacent parts together, such as adjacent modular row units. This structural aspect includes a physical structure, such as one or more beams, rods, castings, forgings, composite components, or other physical components that operate to join adjacent parts of the modular agricultural header and accommodate the physical loads and stresses transmitted into and through the modular agricultural header during use.

A coupler also includes power transmission features that operate to transmit power from one location to another. In some instances, the couplers are configured to transmit different types of power. For example, a coupler includes connectors for transmission of hydraulic power, electrical power, or mechanical power for use onboard of the modular row unit, for transmission to another part of the modular agricultural header, or both. Further, in some implementations, the couplers of a modular agricultural header includes a common interface to facilitate interchangeability of the modular row units. For example, a common interface facilitates removal of one or more modular row unit from the modular agricultural header or addition of modular row units to the modular agricultural header. In some instances, the coupler may include a shaft that interlocks with a shaft of an adjacent modular row unit to transmit mechanical power. In instances where a modular row unit has an integrated coupler, the shaft of one modular row unit interlocks with a shaft of an adjacent modular row unit to transmit the mechanical power. Further, in some implementations, a coupler may include a plurality of mechanical power transmitters, for example, in the form of a plurality of rotatable shafts. These shafts can be used to transmit mechanical power for one or more actuators, conveyors, or other physical components, such as a modular reel, discussed in more detail below. The interlocking shaft are rotatable about an axis, such as a central longitudinal axis, to convey rotational power. Power may also be transmitted by a reciprocating device, such as a reciprocating bar or rod, to transmit mechanical power. For example, a cutter bar section of one modular row unit can be connected to a cutter bar section of and adjacent modular row unit, and reciprocating movement of one of the connected cutter bar sections is transmitted to the adjacent cutter bar section. In this way, a cutter bar assembly, formed from the combination of cutter bar sections of the respective modular row units, is operated to sever crop during a harvesting operation.

In some instances, the couplers include conduits and valves to transmit hydraulic power along from one modular row unit to another along the modular agricultural header. In some instances, electrical connectors, cables, wires, other electrical components, or a combination thereof can be used to transmit electrical power from one modular row unit to another via the coupler.

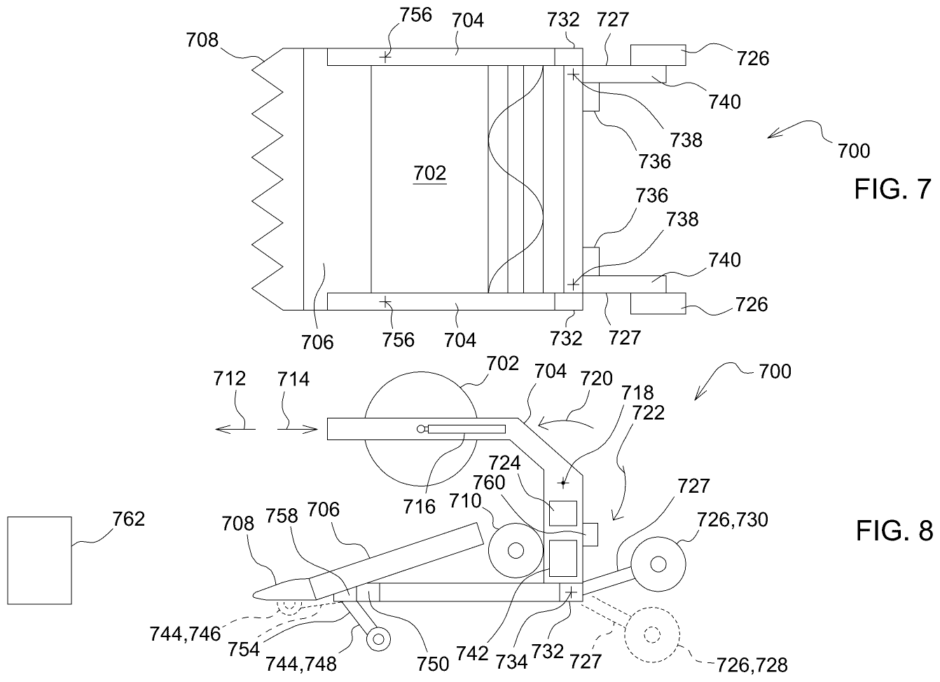

A modular row unit within the scope of the present disclosure, such as modular row unit 26 and modular row unit 506, may form part of a modular corn header used to harvest corn, flowers, sorghum, or similar crops or modular draper header used to harvest crops such as wheat, soybeans, peas, and other grains. FIGS. 7 and 8 are diagrammatic top and side views, respectively, of an example modular row unit 700 of a modular draper header. The modular row unit 700 includes a reel section 702 mounted on reel arms 704, a first conveyor portion 706, and a cutter bar portion 708. In this example, the first conveyor portion 706 includes an endless draper belt that is movable over rollers to move severed crop along the modular agricultural header. One or more of these rollers may be powered, e.g., electrically power, hydraulically power, or mechanically powered. In some implementations, a direction of movement of the endless draper belt (e.g., a direction of rotation of the endless draper belt over the rollers) is selectable so that a modular row unit can be included in any location along the modular agricultural header and be operable to transport severed crop material towards the engagement portion, which may be similar to engagement portion 25 or 520. The engagement portion may include a conveyor, which may include an endless conveyor belt, that is operable to transport the severed crop material into the feederhouse of the agricultural harvester.

The modular row unit 700 also includes a second conveyor portion 710. The second conveyor portion 710 is an auger section that is rotatable to transport crop material laterally towards the engagement portion. The auger sections of adjacent modular row units connect, such as via a coupler, to transmit rotation from one auger section to another. In combination, the different auger sections define an auger that rotates to move the harvested crop material towards the engagement portion, where the crop material is subsequently transferred to the feederhouse of an agricultural harvester. A direction of rotation of the second conveyor portion 710 is selectable to accommodate a position of the modular row unit anywhere along the modular agricultural header, e.g., on either side of a longitudinal centerline of the modular agricultural header, which may be similar to longitudinal centerline 42.

In some implementations, the reel section 702 is movable along the reel arms 704 in the directions of 712 and 714, for example, in response to actuation of one or more actuators 716. In some implementations, the reel arms 704 are pivotable about axis 718 in the rotational directions of arrows 720 and 722, for example, in response to actuation of one or more actuators 724. Example actuators 716 and 724 may be linear actuators, rotary actuators, electric actuators, hydraulic actuators, mechanical actuators, or combinations thereof. Altering a position of the reel section 702 in this way provides for altering how the reel section 702 (and the other reel sections forming a reel of the modular agricultural header) engages incoming crops for harvest. Further, movement of the different reel sections 702 and the reel arms 704 of the modular row units 700 of a modular agricultural header can be coordinated such that the reel sections 702 and reel arms 704 operate in unison so that the reel formed thereby operates in a unified manner.

The modular row unit 700 also includes first ground engaging components 726. Although two first ground engaging components 726 are included, in other implementations, additional or fewer first ground engaging components 726 may be included. In the illustrated example, the first ground engaging components 726 are provided on arms 727. Example first ground engaging components 726 include wheels, tires, track assemblies, and combinations thereof. Further, the first ground engaging components 726 may include other devices operable to transport the modular row unit 700 over a surface. The first ground engaging components 726 are movable between an extended position, indicated by reference number 728, and a retracted position, indicated by reference number 730. In some implementations, one or more actuators 732. Example actuators include linear actuators, rotary actuators, hydraulic actuators, electrical actuators, mechanical actuators, or a combination thereof. The first ground engaging components 726 are pivotable about axis 734 to move the first ground engaging components 726 between the extended position 728 and the retracted position 730. In some implementations, the first ground engaging components 726 are manually movable between the extended position 728 and the retracted position 730.

In some implementations, one or more of the first ground engaging components 726 is steerable. For example, one or more actuators 736 are configured to pivot the first ground engaging components 726 about a respective vertical axis 738. As a result, rotation of the first ground engaging components 726 about the axis in response to the actuators 736 is operable to change a direction of movement of the modular row unit 700. Example actuators 736 include linear actuators, rotary actuators, electrical actuators, hydraulic actuators, mechanical actuators, or combinations thereof. In some implementations, the actuators 736 may be omitted, and steering of the modular row unit 700 may be performed manually, such as by an operator.

In some implementations, one or more of the first ground engaging components 726 are powered, such as by one or more motive devices 740. Example motive devices 740 include an electric motor or internal combustion engine. In the illustrated example, each of the first ground engaging components 726 has one of the motive devices 740 coupled thereto and configured to drive (e.g., rotate) the respective first ground engaging component 726. In other implementations, a single motive device 740 is operable to drive both first ground engaging components 726. In still other implementations, a single ground engaging component 726 is drive by one or more motive devices 740. In some implementations, the motive devices 740 are omitted, and the modular row unit 700 is movable manually, such as by an operator.

The example modular row unit 700 also includes a power supply 742 that supplies power, e.g., electrical power or a fuel, to the motive device or devices 740. In this way, the motive devices 740, powered by the power supply 742, drives the first ground engaging components 726 to move the modular row unit 700 over the ground. Consequently, the modular row unit 726 is self-propelled and self-powered.

The modular row unit 700 also includes one or more second ground engaging components 744. Although two second ground engaging components 744 are included, in other implementations, additional or fewer second ground engaging components 744 may be included. The second ground engaging component 744 is movable between a retraced position (indicated by reference number 746) and an extended position (indicated by reference number 748). In some implementations, the second ground engaging components 744 are manually movable between the extended position 748 and the retracted position 746. In some implementations, the second ground engaging components 744 are extended to support or stabilize the modular row unit 700 when disconnected from a modular agricultural header. In some implementations, the second ground engaging components aid in moving the modular row unit 700 from one location to another when disconnected form a modular agricultural header. In some implementations, the second ground engaging component 744 includes an arm 750 and a wheel 752 rotatably connected to the arm 750. In some implementations, the second ground component 744 omits the wheel 752.

Movement of the second ground engaging components 744 may be caused by respective actuators 754. Example actuators 754 may be any type of actuator configured to move the second ground engaging components 744 between the retracted position 746 and the extended position 748, including those identified herein. In some implementations, the second ground engaging components 744 are pivotable about vertical axes 756. In this way, the second ground engaging components 744 may be used to steer movement of the modular row unit 700 over the ground, such as when the modular row unit 700 is not connected to a modular agricultural header. Actuators 758, such as any of those described herein or otherwise operable to pivot the second ground engaging components 744 about the vertical axes 756, are included. In still other implementations, the second ground engaging components 744 are motorized. Thus, in some instances, the second ground engaging components 744 are used to propel the modular row unit 700 over a surface. In some instances, the actuators 754, 758, or both may be omitted and moving the second ground engaging components 744 about the respective axes may be performed manually.

The first ground engaging components 726 and the second ground engaging components 744 are extended, for example, to support the modular row unit 700 above a surface when disconnected from a modular agricultural header. Further, in some implementations, with the ground engaging components 726 and 744 extended, the modular row unit 700 is movable over the ground. Further, in some implementations, the modular row unit 700 is movable over the ground in response to the motive devices 740 using power from the power supply 742.

In some implementations, the modular row unit 700 is steerable, for example, with rotation of the first ground engaging components 726, the second ground engaging components 744, or both. Still further, in some implementations, control of the movement of the modular row unit 700 from one location to another is controlled by a user, such as by using an input device 760 or a remote device 762 that is connected to the modular row unit 700 via a wired or wireless connection. In some implementations, changing a configuration of the modular row unit 70, movement of the modular row unit 700, or both is performed manually.

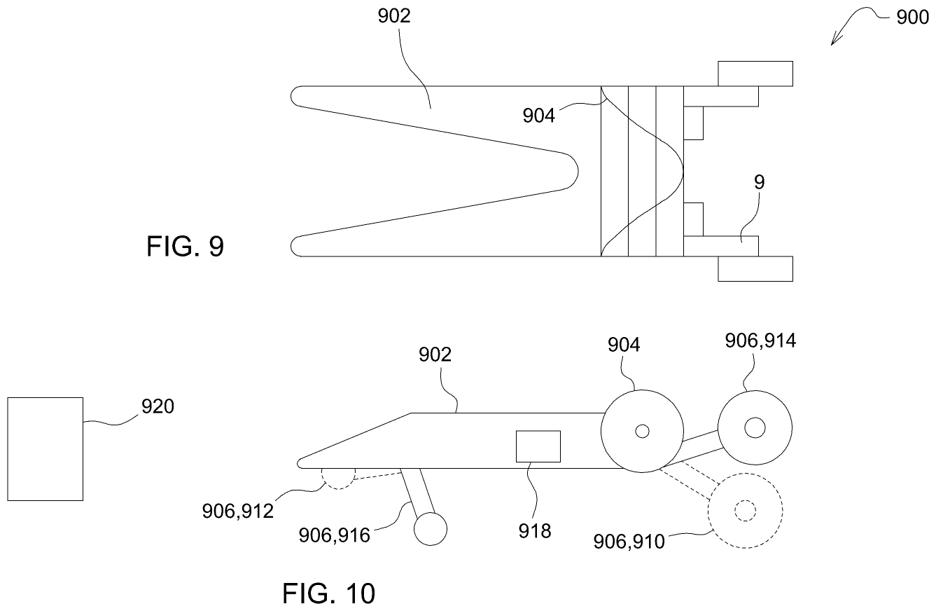

FIGS. 9 and 10 show another example modular row unit 900. The modular row unit 900 is an example modular row unit, such as a corn row unit, that includes a row harvester unit 902 and a conveyor section 904. Example modular row units include modular row units configured to harvest flowers (e.g., sunflowers), corn, sorghum, and similar types of crops. The row harvester unit 902 is configured to gather corn stalks, sever corn stalks, strip corn ears from stalks, or a combination of these. In the illustrated example, the conveyor section 904 is a section of an auger. The conveyor section 904 is configured to transport separated corn ears along a modular agricultural header. Particularly, when incorporated into a modular row header, the conveyor sections 904 of adjacent modular row units 900 connect and rotate in unison to transport separated corn ears to an engagement portion of the modular row header, which may be similar to engagement portion 25 or 520, and, from there, the corn ears are transported into a feederhouse of an agricultural harvester.

Similar to the modular row unit 700, the modular row unit 900 includes first ground engaging components 906 and second ground engaging components 908. The first and second ground engaging components 906 and 908 are shown both in respective retracted positions 910 and 912 as well as in respective extended positions 914 and 916. The first and second ground engaging components 906 and 908 may be similar to first and second ground engaging components 726 and 744, respectively. Consequently, descriptions thereof are omitted.

Also similar to the modular row unit 700, the modular row unit 900 is movable over the ground when detached from a modular agricultural header, such as in response to a force applied by a user (e.g., pulling or pushing), or, in some implementations, the modular row unit 900 is self-propelled, steerable, or both, for example, as described earlier. In some implementations, movement of the modular row unit 900 is controlled via a user input device 918 provided on the modular row unit 900 or a remotely located input device 920 that is connected to the modular row unit via a wired or wireless connection.

Although a draper modular row unit, such as the modular row unit 700, and a corn modular row unit, such as the modular row unit 900, are described, the scope of the present disclosure is not so limited. Rather, other types of modular row units for other types of modular agricultural headers are encompassed. For example, the present encompasses a modular pickup header and the modular row units associated therewith. Other types of modular agricultural headers are also contemplated.

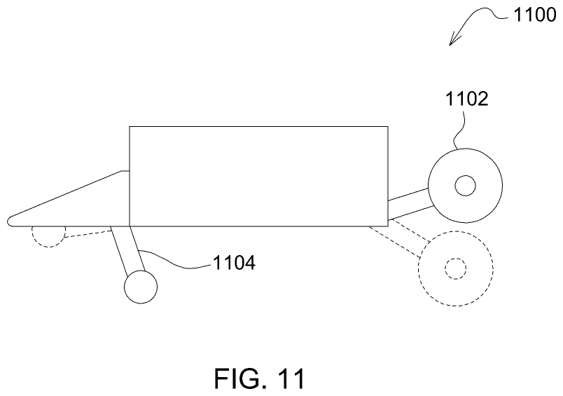

FIG. 11 is a diagrammatic side view of an example modular lateral end portion 1100, which may be similar to end portions 28, 30, 512, and 514. Similar to the modular row units 700 and 900, the modular end portion 1100 includes ground engaging components, such as first ground engaging components 1102 and second ground engaging components 1104. Similar to the ground engaging components described earlier in the context of modular row units 700 and 900, the first and second ground engaging components 1102 and 1104 are movable between an extended position and a retracted position. The modular end portion 1100 may be movable in response to forces applied by a user (e.g., push or pull). In some instances, the modular lateral end portion 1100 may be self-propelled, steerable, or both, as also described earlier. Further, in some implementations, movement of the modular lateral end portion 1100 may be controlled via an input device 1106 provided on the modular lateral end portion 1100 or via a remote input device 1108 this connected to the modular end portion via a wired or wireless connection. In some implementations, altering a configuration of the modular lateral end portion 1100, such as extending or retracting ground engaging components 1102 and 1104, moving the modular lateral end portion 1100, or both may be performed manually.

The ground engaging components described in the context of the modular row units 700 and 900 and the modular lateral end portion 1100 can be retracted when these modular row units 700 and 900 and modular lateral end portion 1100 is connected to a modular agricultural header. The ground engaging components can be extended when connecting to a modular agricultural header, disconnecting from a modular agricultural header, or moving these modular row units 700 and 900 or modular lateral end portion 1100 when disconnected from a modular agricultural header.

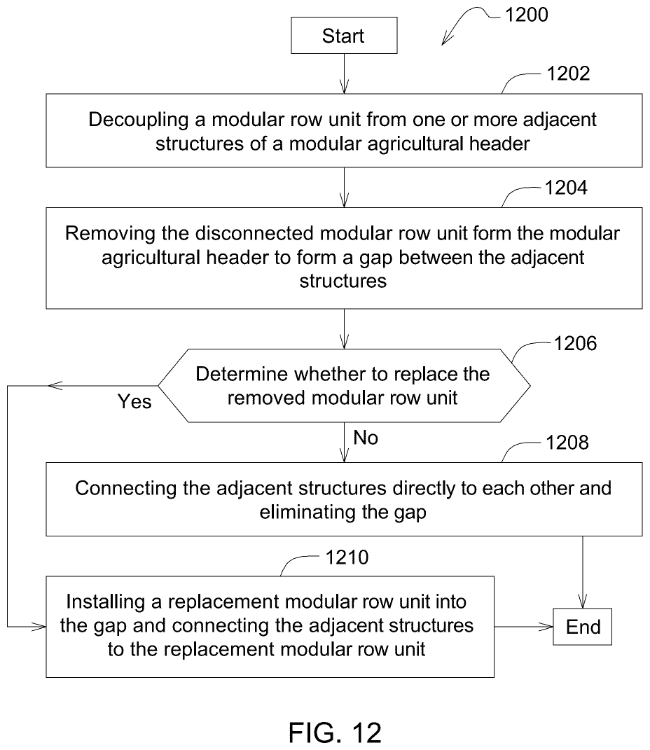

FIG. 12 is a flowchart of an example method 1200 for altering a configuration of a modular agricultural header, such as modular agricultural header 12 or 500. At 1202, a modular row unit, such as any type of modular row unit within the scope of the present disclosure, is decoupled from one or more adjacent structures, such as an adjacent modular row unit, an engagement portion, a lateral end portion, or a combination of these. For example, a modular row unit disposed directly between and coupled to two adjacent modular row units is decoupled from both of the adjacent modular row units. In another example, a modular row unit disposed directly between and coupled to an engagement portion and another modular row unit is decoupled from both the engagement portion and the other modular row unit. In still another example, the modular row unit is disposed directly between and coupled to a lateral end portion and another modular row unit and is decoupled from both. Still further, a modular row unit may be disposed directly between and coupled to an engagement portion and a lateral end portion and is disconnected from both. At 1204, the disconnected modular row unit is removed from the agricultural header, forming a gap between the adjacent structures. At 1206, a decision is made as to whether replace the removed modular row unit. At 1208, the modular row unit is not replaced, and the structures adjacent to the removed modular row header are directly connected to each other, thereby eliminating the gap. At 1210, the removed modular row unit is to be replaced. Consequently, a replacement modular row unit is introduced into the gap, and the adjacent structures are coupled to the replacement modular row unit. Replacement of a modular row unit may occur when a modular row unit is damaged and a replacement is available. Replacement of a modular row unit may not occur where a replacement modular row unit is not available or where a reduced harvesting area is desired.

In the context of the above description, a modular row unit being directly between adjacent structures means that another modular row unit is not disposed between the modular row unit and the adjacent structure, whether the adjacent structure is another modular row unit, a lateral end portion, or an engagement portion. Further, the example method 1200 is not limited to the feature or order of features provided. In other instances, the method 1200 may be varied to include additional, fewer, or different features. Further, although a modular row unit is discussed in the context of FIG. 12, the example method 1200 is also applicable to removing or adding a modular lateral end portions.

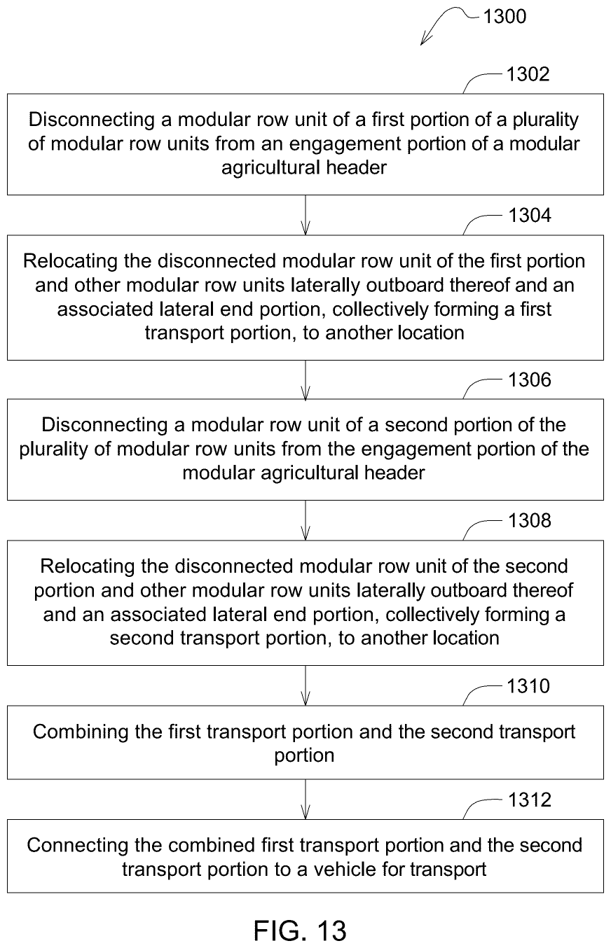

FIG. 13 is a flowchart for another example method 1300 for converting a modular agricultural header, such as modular agricultural header 12 or 500, for transport. At 1302, a modular row unit of a first portion of a plurality of modular row units, such as first portion 38, described earlier, is disconnected from an engagement portion, such as engagement portion 25. At 1304, the disconnected modular row unit and the modular row units coupled thereto, for example the modular row units disposed laterally outward from the disconnected modular row unit, and an associated lateral end portion, collectively referred to as a first transport potion, are relocated to another location, such as a location rearward of an agricultural harvester connected to the modular agricultural header. At 1306, a modular row unit of a second portion of modular row units, such as second portion 40, is disconnected from the engagement portion. At 1308, the other disconnected modular row unit and all modular row units coupled thereto, for example the modular row units disposed laterally outward from the disconnected modular row unit, and an associated lateral end portion, collectively referred to as a second transport portion, are relocated to another location, such as the location rearward of the agricultural harvester connected to the modular agricultural header. At 1310, the first transport portion and the second transport portion are combined, and, at 1312, the combined first and second transport portions are connected to a vehicle, such as the agricultural harvester, for transport. In some instances, the combined first and second transport portions are connected at an aft end of the vehicle. Thereafter, the vehicle is operated to relocate the modular agricultural header to a new location.

The example method 1300 can be varied to include addition, fewer, or different features. For example, in some instances, disconnection of the other modular row unit and formation of the second transport portion may be omitted. Further, although the modular row unit directly adjacent to the engagement portion is disconnected therefrom, in other implementations, a modular row unit that is not directly adjacent to the engagement portion is disconnected. Thus, in some instances, one or more modular row units may remain attached to one or both of the lateral sides of the engagement portion. In some instances, the first transport portion may have a different size than the second transport portion. In some implementations, the first transport portion and the second transport portion may be connected before being relocated.

Without in any way limiting the scope, interpretation, or application of the claims appearing below, a technical effect of one or more of the example implementations disclosed herein is improve efficiency and reduce costs associated with crop harvesting by allowing a modular row unit to be replaced or omitted, such as when the modular row unit becomes damaged, thereby allowing a harvesting operation to continue. Another technical effect of one or more of the example implementations disclosed herein is reducing labor and cost associated with relocating an agricultural header from one location to another. The modular nature of a modular agricultural header allows for a portion of the header to remain attached to the agricultural harvester and relocation other portions of the modular agricultural header for transportation, such as to another location for connection to the agricultural harvester.

While the above describes example implementations of the present disclosure, these descriptions should not be viewed in a limiting sense. Rather, other variations and modifications may be made without departing from the scope and spirit of the present disclosure as defined in the appended claims.

What is claimed is:

1. A modular agricultural header comprising:
a first portion including a mount configured to selectively couple to an agricultural harvester;
a second portion defining a first lateral end of the agricultural header; and
a first modular row unit removably disposed between the first portion and the second portion, a separation distance between the first portion and the second portion being altered in response to coupling or decoupling of the first modular row unit therebetween.

2. The modular agricultural header of claim 1, further comprising:
a third portion defining a second lateral end of the agricultural header, opposite the first lateral end; and
a second modular row unit removably disposed between the first portion and the third portion.

3. The modular agricultural header of claim 1, further comprising a coupler disposed between the first modular row unit and the first portion, between the first modular row unit and the second portion, or between the first modular row unit and a second modular row unit.

4. The modular agricultural header of claim 3, wherein the coupler comprises a connection for at least one of the group consisting of a hydraulic connection, an electrical connection, a structural connection, a drive connection, and combinations thereof.

5. The modular agricultural header of claim 3, wherein the coupler is formed on the first modular row unit.

6. The modular agricultural header of claim 3, wherein the first modular row unit includes an engagement site to which a portion of the coupler removably attaches.

7. The modular agricultural header of claim 3, wherein the coupler comprise a first coupler, wherein the first coupler is formed on a first side of the first modular row unit, and wherein the first modular unit includes an engagement site configured to engage with a second coupler.

8. The modular agricultural header of claim 1, wherein the first modular row unit comprises a first ground engaging component proximate a leading end of the first modular row unit and a second ground engaging component proximate to a trailing end of the first modular row unit.

9. The modular agricultural header of claim 8, wherein the second ground engaging component is powered and configured to propel the first modular row unit along a surface.

10. The modular agricultural header of claim 8, wherein the first ground engaging component is steerable.

11. An agricultural header comprising:
an engagement portion configured to connect to an agricultural harvester;
a first end portion disposed at a first lateral end of the agricultural header;
a second end portion disposed at a second lateral end of the agricultural header;
a plurality of modular row units, a first portion of the plurality of modular row units removable disposed and interconnected between the engagement portion and the first end portion and a second portion of the plurality of modular row units disposed and interconnected between the engagement portion and the second end portion, each of the modular row units occupying a position between the engagement portion and the respective one of the first end portion or the second end portion, each of the plurality of modular row units being selectively removable from associated position; and
a width, the width being altered in response to addition or removal of one or more of the plurality of modular row units from the associated space thereof.

12. The agricultural header of claim 11, further comprising a coupling disposed between and connecting adjacent modular row units.

13. The agricultural header of claim 11, wherein each of the modular row units comprises a first lateral side and a second lateral side, wherein the first lateral side comprises a coupler, wherein the coupler is configured to connect to an adjacent modular row unit, and wherein the second lateral side comprises an engagement site configured to engage with a coupler of an adjacent modular row unit to form a connection therebetween.

14. A method of configuring an agricultural header that includes an engagement portion, a first lateral end portion disposed at a first latera end of the agricultural header, a second lateral end portion disposed at a second lateral end of the agricultural header, and a plurality of modular row units, a first portion of the modular row units disposed between the engagement portion and the first lateral end portion and a second portion of the modular row units disposed between the engagement portion and the second lateral end portion, the method comprising:
one of selectively adding one or more of the modular row units to the first portion of modular row units or the second portion of the modular row units or removing one or more of the modular row units from the first portion of modular row units or the second portion of the modular row units; and
altering a lateral width of the agricultural header in response to the one of selectively adding one or more of the modular row units to the first portion of modular row units or the second portion of the modular row units or removing one or more of the modular row units from the first portion of modular row units or the second portion of the modular row units.

15. The method of claim 14, wherein altering a lateral width of the agricultural header in response to selectively adding one or more of the modular row units to the first portion of modular row units or the second portion of the modular row units comprises:
disconnecting a first modular row unit of the plurality of modular row units from one of an adjacent modular row unit of the plurality of modular row units, the first lateral end portion, the second lateral end portion, or the engagement portion;
increasing a separation distance between the first lateral end portion and the second lateral end portion to form a gap;
inserting second row unit in the gap between the first lateral end portion and the second lateral end portion;
coupling a first lateral side of the second modular row unit to the first modular row of the plurality of modular row units; and
coupling a second lateral side of the second modular row unit to one of the adjacent modular row unit, the first lateral end portion, the second lateral end portion, or the engagement portion.

16. The method of claim 15, wherein altering a lateral width of the agricultural header in response to selectively removing one or more of the modular row units from the first portion of modular row units or the second portion of the modular row units comprises:
disconnecting a first modular row unit of the plurality of modular row units from one of an adjacent modular row unit of the plurality of modular row units, the first lateral end portion, the second lateral end portion, or the engagement portion;
removing the first modular row unit to form a gap between the first lateral end portion and the second lateral end portion;
decreasing a separation distance between the first lateral end portion and the second lateral end portion to eliminate the gap; and
coupling the adjacent modular row unit to one of a second modular row of the plurality of modular row units, the first lateral end portion, the second lateral end portion, or the engagement portion.

17. A method for converting, for transportation, a modular agricultural header including an engagement portion configured to engage an agricultural harvester, a first lateral end portion disposed at a first latera end of the agricultural header, a second lateral end portion disposed at a second lateral end of the agricultural header, and a plurality of modular row units, a first portion of the modular row units disposed between the engagement portion and the first lateral end portion and a second portion of the modular row units disposed between the engagement portion and the second lateral end portion, the method comprising:
disconnecting a first modular row unit of the first portion of the plurality of modular row units from one of an adjacent modular row unit of the first portion of the plurality of modular row units or the engagement portion to form a first transport portion;
locating the first transport portion to an aft end of the agricultural harvester; and
connecting the first transport portion to the aft end of the agricultural harvester.

18. The method of claim 17, further comprising orienting the first transport portion in a longitudinal arrangement.

19. The method of claim 17, further comprising:
disconnecting a first modular row unit of the second portion of the plurality of modular row units from one of an adjacent modular row unit of the second portion of the plurality of modular row units or the engagement portion to form a second transport portion; and
connecting the first transport portion and the second transport portion to form a consolidated transport portion, and
wherein connecting the first transport portion to the aft end of the agricultural harvester includes connecting the consolidated transport portion to the aft end of the agricultural harvester.

20. The method of claim 17, wherein orienting the first transport portion in the longitudinal arrangement includes orienting the consolidated transport portion in the longitudinal arrangement.
